(19) United States
(12) Patent Application Publication
(10) Pub. No.: US 2025/0366684 A1
(43) Pub. Date: Dec. 4, 2025

(54) BLOWER UNIT FOR A SUCTION DEVICE

(71) Applicant: BSH Hausgeräte GmbH, München (DE)

(72) Inventors: Christian SCHELER, Rödelmaier (DE); Christian STOBERT, Hohenroth (DE); Marcel STENGEL, Sulzfeld (DE); Fabian KASTNER, Oberelsbach (DE)

(21) Appl. No.: 19/206,347

(22) Filed: May 13, 2025

(30) Foreign Application Priority Data
May 28, 2024 (DE) 10 2024 204 971.9

(51) Int. Cl. A47L 9/10; A47L 5/22; A47L 9/22

(52) U.S. Cl. CPC A47L 9/104; A47L 5/22; A47L 9/22

(57) ABSTRACT

A blower unit for a suction device has a blower, which is embodied to effect a suction-air flow along a flow direction running from the suction side to the exhaust-air side of the blower unit during operation. The blower unit furthermore has a blower capsule in which the blower is arranged, and a suction-side bearing and an exhaust-air-side bearing for supporting the blower on the inner side of the blower capsule. In addition, the blower unit contains a protective element arranged on the suction-side bearing, which is embodied to be flowed through by the suction-air flow and to provide contact protection for the blower. The protective element is arranged on the suction-side bearing in such a way that the protective element is at a distance from the inner side of the blower capsule when the blower is in operation.

### CROSS-REFERENCE TO RELATED APPLICATION

This application claims the priority, under 35 U.S.C. § 119, of German Patent Application DE 10 2024 204 971.9, filed May 28, 2024; the prior application is herewith incorporated by reference in its entirety.

### FIELD AND BACKGROUND OF THE INVENTION

The invention relates to a blower unit for a suction device, in particular for a cordless and/or handheld vacuum cleaner.

A suction device, in particular a handheld vacuum cleaner, typically contains a suction unit that can be carried and guided by a user by hand. The suction unit has a blower unit with a blower that is operated by electrical energy from an electrical energy store of the suction unit. The blower is embodied to generate a suction-air flow in order to suck contaminants through the suction mouth of the suction unit into the collection container of the suction unit. The suction mouth of the suction unit is typically embodied as a coupling, via which one of a number of different accessories can be connected to the suction unit in each case. Examples of accessories include suction tubes, floor nozzles, wet cleaning nozzles, etc.

The blower of the suction device, in particular the suction unit, can be arranged inside a blower capsule of the blower unit, wherein the blower capsule provides the contact protection for the blower. The blower capsule has an inlet region through which the suction-air flow is drawn into the blower capsule. The blower unit typically has a substantial influence on the suction efficiency and noise emission of a suction device.

### SUMMARY OF THE INVENTION

The present document addresses the technical object of providing a blower unit for a suction device which has reliable contact protection, low flow resistance and low noise emission.

The object is achieved by the subject matter of the independent claim. Advantageous embodiments are in particular defined in the dependent claims, described in the following description or illustrated in the attached drawing.

According to one aspect, a blower unit for a suction device (in particular for a (handheld and/or battery-operated) vacuum cleaner) is described. The blower unit comprises a blower, which is embodied to effect a suction-air flow along a flow direction during operation, wherein the flow direction runs from the suction side to the exhaust-air side of the blower unit. The blower unit can have a longitudinal axis that runs from the suction side to the exhaust-air side of the blower unit. The flow direction can run substantially parallel to the longitudinal axis.

The blower unit furthermore contains a blower capsule in which the blower is arranged. The blower capsule can be made of plastic. The blower capsule can be embodied to enable the blower unit to be fixed within the suction device. Furthermore, the blower capsule can be embodied as a (protective) housing for the blower.

In addition, the blower unit contains a suction-side bearing and an exhaust-air-side bearing for supporting the blower on the inner side of the blower capsule. The blower capsule can have a suction-side capsule part and an exhaust-air-side capsule part, which can be detachably connected to one another, for example, via a snap-in connection, or are detachably connected to one another. The suction-side bearing can be embodied to support the blower on the inner side of the suction-side capsule part of the blower capsule and the exhaust-air-side bearing can be embodied to support the blower on the inner side of the exhaust-air-side capsule part of the blower capsule.

The suction-side and/or the exhaust-air-side bearing are preferably resilient (for damping and/or decoupling vibrations). In particular, the suction-side bearing and/or the exhaust-air-side bearing can in each case be made of a resilient material, in particular rubber.

The blower unit furthermore contains a protective element arranged on the suction-side bearing, which is embodied to be flowed through by the suction-air flow and to provide contact protection for the blower.

The protective element can have a grille region with a plurality of grille openings, wherein the suction-air flow flows through the grille region when the blower is in operation. The individual grille openings can in each case be hexagonal in shape, thereby effecting particularly low flow resistance. The grille region of the protective element can be curved (in particular outwardly), thereby enabling the flow resistance to be further reduced.

The individual grille openings of the grille region of the protective element can in each case have an inner diameter of in each case 8.6 mm or less, preferably 5.6 mm or less, particularly preferably between 3 mm and 4 mm. This enables the provision of particularly reliable contact protection. Furthermore, the protective element can be made of metal, in particular a metal sheet, thereby enabling contact protection to be further improved.

The protective element is preferably arranged on the suction-side bearing in such a way that the protective element is at a (specific) distance from the inner side of the blower capsule during operation of the blower. The protective element can in particular be arranged on the suction-side bearing in such a way that the protective element is pulled away from the inner side of the blower capsule, and in particular toward the exhaust-air side of the blower, by the action of the suction-air flow (along the longitudinal axis) during operation of the blower, so that the protective element is at a distance from the inner side of the blower capsule. The distance can be between 0.1 mm and 0.5 mm. The protective element can have a specific thickness perpendicular to the flow direction of the suction-air flow. The distance can, for example, be between 0.5 and 1.2 times the thickness of the protective element.

The protective element (for providing contact protection) can thus be arranged in the blower unit in such a way that the protective element does not directly contact the (relatively hard) housing capsule during operation of the blower, so that vibrations of the protective element (generated, for example, by the suction-air flow) are not transmitted directly to the housing capsule. This enables a particularly low-noise housing capsule to be provided.

The blower capsule, in particular the suction-side capsule part, can have a front wall on the suction side of the blower unit, wherein the front wall has a recess, in particular a circular recess. The protective element (in particular the grille region of the protective element) can cover the recess of the front wall of the blower capsule from the inner side of the housing capsule, so that particularly reliable contact protection is provided.

The suction-side bearing can have a (annular) outer region facing the inner side of the front wall of the blower capsule. A rib, in particular an annular rib, which protrudes from the surface of the outer region, is arranged on the outer region of the suction-side bearing and contacts the inner side of the front wall of the blower capsule. The rib can define the distance between the protective element and the inner side of the blower capsule in a particularly precise and reliable manner (and thus reliably reduce the noise generated by the blower unit).

The suction-side bearing can furthermore have an (annular) inner region facing the inner side of the front wall of the blower capsule. In addition, the protective element can have an edge region (enclosing the grille region of the protective element), which abuts the inner region of the suction-side bearing. Thus, the edge region of the protective element can be arranged between the inner side of the front wall of the blower capsule and the inner region of the suction-side bearing.

The blower unit can be embodied in such a way that the edge region of the protective element is pulled toward the inner region of the suction-side bearing, in particular by the action of the suction-air flow, when the blower is in operation, so that the aforementioned distance between the edge region of the protective element and the inner side of the front wall of the blower capsule is produced. Placing the protective element directly on the suction-side bearing enables the distance between the protective element and the inner side of the front wall of the blower capsule to be set in a particularly reliable manner. Furthermore, placing the protective element on the resilient suction-side bearing can provide particularly reliable contact protection.

The (annular) inner region of the suction-air side bearing can enclose a (circular) recess of the suction-air side bearing. The recess of the suction-air side bearing can have approximately the same diameter as the recess of the front wall of the blower capsule. The protective element can be embodied to cover the recess of the suction-air side bearing (with the grille region of the protective element).

The protective element can have a side wall extending away from the edge region of the protective element (along the longitudinal axis) toward the exhaust-air side of the blower unit. Furthermore, the suction-side bearing can have a groove, in particular an annular groove, between the inner region and the outer region in order to accommodate the side wall of the protective element. Furthermore, the protective element can have one or more fixing lugs (possibly resilient in the radial direction) on the side wall and/or as part of the side wall, which are embodied to effect a force-fitting connection between the protective element and the suction-side bearing within the groove of the suction-side bearing. This enables the protective element to be arranged in the blower unit in a particularly efficient and reliable manner. The use of a circular cylindrical side wall enables the protective element to be arranged in the annular groove of the suction-side bearing in any angular position with respect to rotation around the longitudinal axis.

The suction-side bearing can have a side wall extending from the outer region of the suction-side bearing (along the longitudinal axis) toward the exhaust-air side of the blower unit. The side wall can run around the longitudinal axis of the blower unit. The side wall can be corrugated in the circumferential direction around the longitudinal axis with a plurality of, in particular evenly distributed, corrugation crests (for example between 4 and 30 corrugation crests). The side wall of the suction-side bearing can be embodied to contact the inner side of the blower capsule (only) with the plurality of corrugation crests. This can effect particularly reliable support for the blower. Furthermore, it can provide a particularly stable suction-side bearing.

A further aspect describes a suction device and/or a suction unit comprising the blower unit described in this document.

It should be noted that any aspects of the blower unit described in this document and the suction device or suction unit can be combined with each other in a variety of ways. In particular, the features of the claims can be combined with each other in a variety of ways.

Other features which are considered as characteristic for the invention are set forth in the appended claims.

Although the invention is illustrated and described herein as embodied in a blower unit for a suction device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, side view of an example of a suction device with a suction unit, a suction tube and a nozzle according to the invention;

FIG. 2A and FIG. 2B sectional views in each case of a suction unit with a blower and a blower capsule;

FIG. 3A is an exploded, perspective view of a blower unit;

FIG. 3B is a sectional view of the blower unit;

FIG. 3C is a perspective, cut-away view of the blower unit;

FIG. 4A is a perspective view of an example of a protective element and a suction-side bearing;

FIG. 4B is a sectional view of an example of an arrangement of the suction-side bearing and the protective element on the suction-side capsule part of the blower capsule; and

FIG. 4C is a detailed section view of the arrangement of the suction-side bearing and the protective element on the suction-side capsule part of the blower capsule.

### DETAILED DESCRIPTION OF THE INVENTION

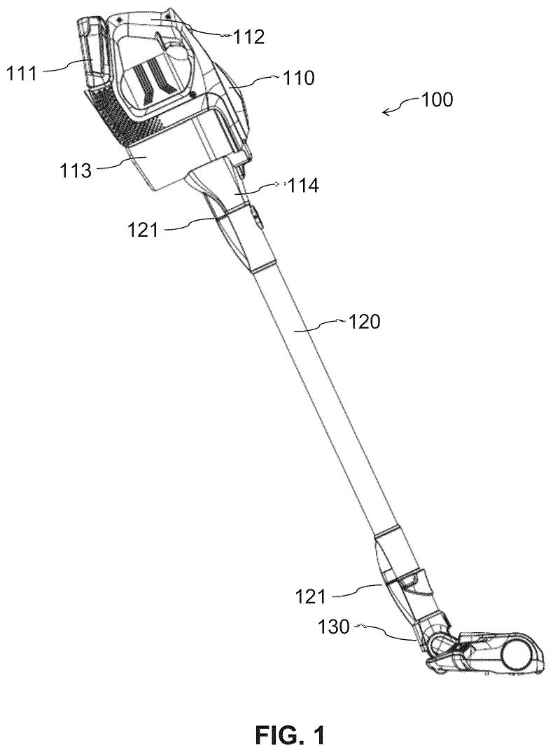

As stated in the introduction, the present document is concerned with providing an efficient, safe and low-noise blower unit for a suction device. Referring now to the figures of the drawings in detail and first, particularly to FIG. 1 thereof, there is shown an example of a (handheld) vacuum cleaner 100 (as an example of a suction device) with a suction unit 110 with an electrical energy store 111. The suction unit 110 has a handle 112, which can be gripped by a user's hand in order to hold the suction unit 110. A blower of the suction unit 110 effects a suction-air flow through the suction mouth 114 of the suction unit 110 via a separator unit 113 of the suction unit 110 up to the blower. The suction unit 110 can be embodied to be used independently as a suction device.

An accessory can be attached to the suction unit 110 via a coupling 121. In the example shown, the suction unit 110 is connected to a suction tube 120 via a coupling 121 which in turn is connected to a floor nozzle 130 via the coupling 121.

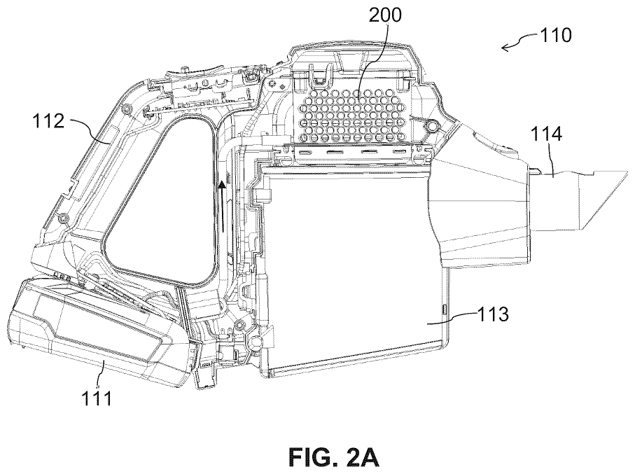

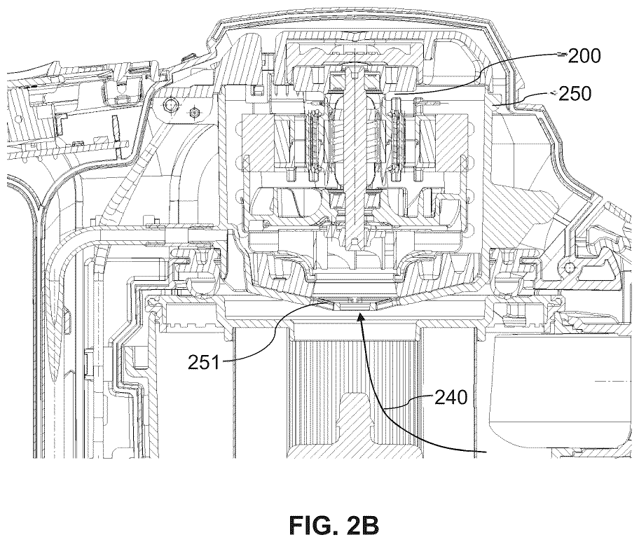

FIG. 2A and FIG. 2B show different views of the suction unit 110 having a blower 200 arranged in a blower capsule 250. The blower capsule 250 has an inlet region 251 through which the suction-air flow 240 is drawn to the blower 200.

The suction efficiency of a suction device 100 depends on the flow resistance of the different components of the suction device 100 through which the suction-air flow 240 flows. These components also include the inlet region 251 of the blower capsule 250 of the blower 200. To provide the smallest possible flow resistance, the inlet region 251 should have the largest possible open area.

The inlet region 251 of the blower capsule 250 is typically arranged directly before the suction opening of the blower 200. To provide the most reliable contact protection, the inlet region 251 should have the smallest possible openings in order to reliably prevent a user's finger (possibly also a child's finger) from reaching the suction opening of the blower 200 through the inlet region 251. Furthermore, the blower capsule 250 should have a certain strength in the inlet region 251 in order to prevent a user from damaging the blower capsule 250 in the inlet region 251 and then reaching the suction opening of the blower 200 with a finger. The strength of the housing capsule 250 can be checked by an impact pressure test (as specified, for example, by the standard DIN EN 60335-1 (VDE 0700-1): 2020-08 Chapter 21).

The blower capsule 250 also influences the transmission of vibrations from the blower 200 to the suction unit 110 and the resulting noise emission.

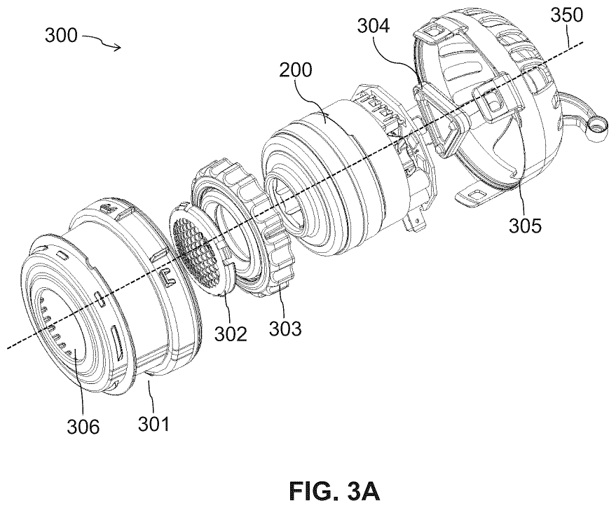

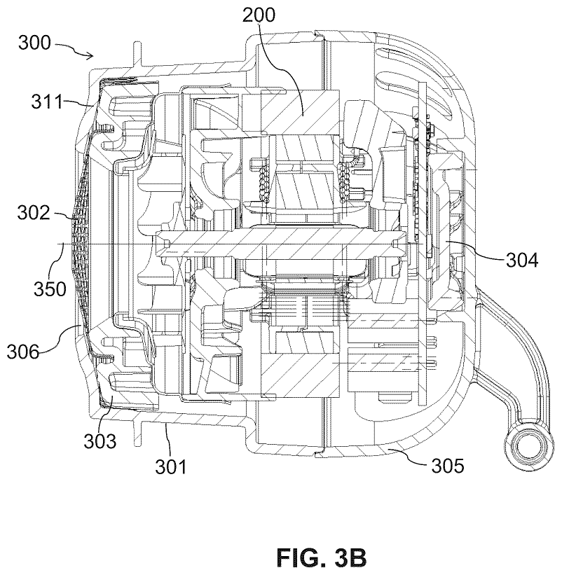

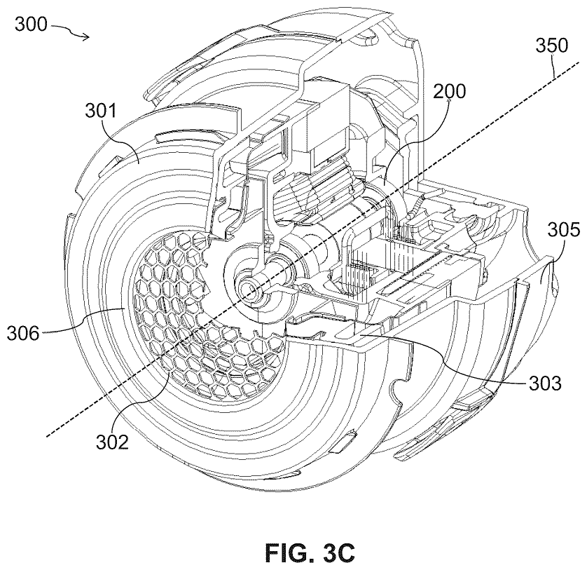

FIGS. 3A to 3C show different views of a blower unit 300 with the blower 200 and the blower capsule 250. In the example shown, the blower capsule 250 contains a suction-side capsule part 301 and an exhaust-air-side capsule part 305, which are embodied to enclose the blower 200. The two capsule parts 301, 305 can, for example, be detachably connected to one another using one or more snap-in connections.

The blower unit 300 can have a longitudinal axis 350, as shown in FIG. 3A. The suction-side capsule part 301 can be arranged along the longitudinal axis 350 before the exhaust-air-side capsule part 305. The blower 200 can be embodied to effect a suction-air flow 240 that flows along the longitudinal axis 350 through the blower unit 300 (from the suction-side capsule part 301 to the exhaust-air-side capsule part 305).

The blower 200 can be supported on the inner side of the housing capsule 250 via one or more bearings 303, 304. The one or more bearings 303, 304 can in each case be embodied as elastomer bearings and/or rubber bearings. The blower unit 300 can in particular have a suction-side bearing 303 via which the suction side of the blower 200 is supported on the suction-side capsule part 301. The suction-side bearing 303 can, for example, be embodied as a ring that encloses the circular suction side of the blower 200 (and can be pushed onto the suction side of the blower 200).

In addition, the blower unit 300 can have an exhaust-air-side bearing 305 via which the exhaust-air side of the blower 200 (on which, for example, the electronics for controlling the blower 200 is arranged) is supported on the exhaust-air-side capsule part 305. In the example shown, the exhaust-air-side bearing 305 is embodied as a three-point bearing or a triangular bearing.

The suction-side capsule part 301 has a side wall that runs around the longitudinal axis 350 in the circumferential direction. In addition, the suction-side capsule part 301 has a front wall 311 that is arranged substantially perpendicular to the longitudinal axis 350. The suction-side bearing 303 can be embodied to contact the inner side of the side wall and the front wall 311 in order to support the blower 200 on the suction-side capsule part 301.

The front wall 311 of the suction-side capsule part 301 has a central (circular) recess 306. The front wall 311 can have a certain overall diameter and the recess 306 can have a recess diameter that is 50% or more, in particular 70% or more, of the overall diameter. In this way, an inlet region 251 of the housing capsule 250 with the lowest possible flow resistance can be provided.

The recess 306 of the front wall 311 is covered by a protective element 302 which provides the contact protection in the inlet region 251 of the housing capsule 250. The protective element 302 is arranged between the front wall 311 and the suction-side bearing 303. The protective element 302 has a plurality of openings, which are preferably arranged in a honeycomb structure in order to minimize the flow resistance. The protective element 302 is furthermore preferably curved in order to increase the surface of the protective element 302 and thereby further reduce the flow resistance. Furthermore, the protective element 302 is preferably made of metal, in particular sheet metal, in order to provide particularly reliable contact protection.

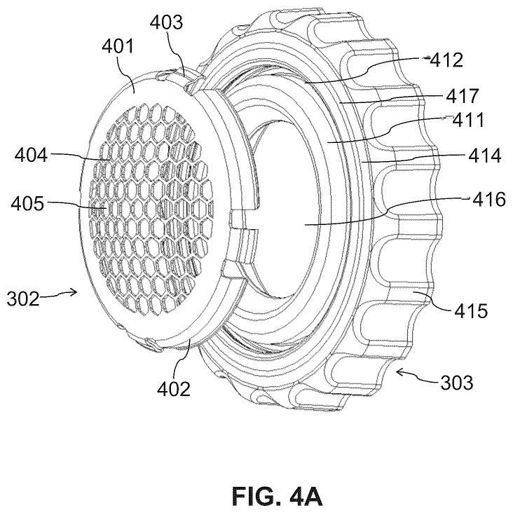

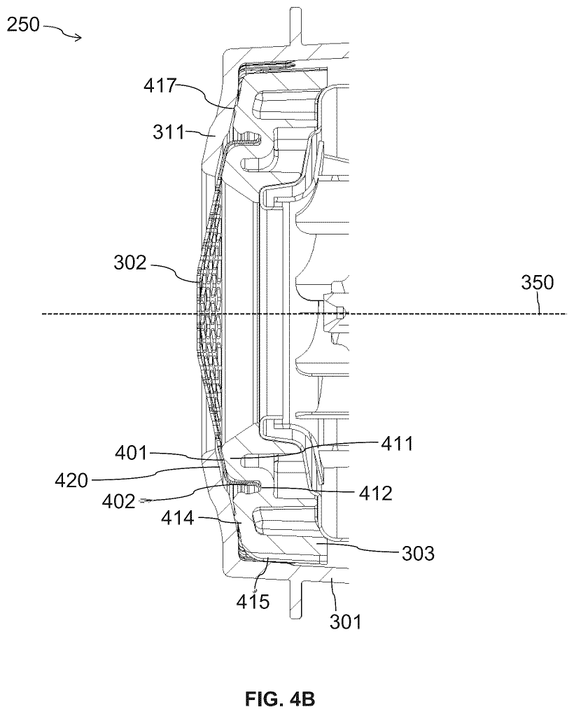

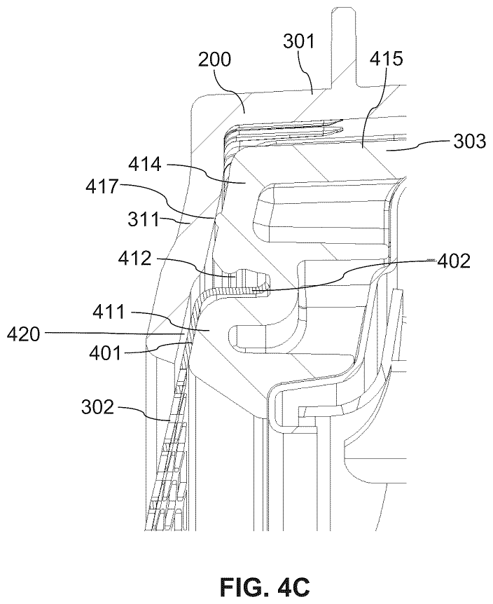

FIG. 4A shows an example of a protective element 302 and an example of a suction-side bearing 303. The protective element 302 has an annular edge region 401 which, in the installed state, faces the inner side of the front wall 311 of the housing capsule 250, in particular the suction-side capsule part 301. The edge region 401 encloses the grille region 404 of the protective element 302, wherein the grille region 404 has a honeycomb-shaped arrangement of grille openings 405. The edge region 401 and the grille region 404 of the protective element 302 form a (curved) base surface which (in the installed state) is arranged substantially perpendicular to the longitudinal axis 350.

The protective element 302 furthermore has a side wall 402 that extends from the base surface along the longitudinal axis 350. The side wall 402 can, for example, have a length along the longitudinal axis 350 of between 0.4 mm and 1 cm. The protective element 302 can have the shape of a crown cork. The side wall 402 of the protective element 302 can be embodied to be arranged in an annular groove 412 of the suction-side bearing 303 in order to secure the protective element 302 to the suction-side bearing 303. The side wall 402 can in each case have an interruption in the circumferential direction at one or more locations, for example at 4 different locations each spaced 90° apart. In other words, the side wall 402 can consist of a plurality of segments in the circumferential direction, wherein a free space is formed between two directly successive segments of the side wall 402 in each case. In each case a (resilient) fixing lug 403, which is embodied to be moved in the radial direction (with respect to the longitudinal axis 350) can be arranged in the free space between two segments of the side wall 402. The one or more fixing lugs 403 can effect particularly reliable fixing of the side wall 402 in the groove 412 of the suction-side bearing 303 (since the one or more fixing lugs 403 press against the outer inner wall of the groove 412 in the radial direction, thereby clamping the protective element 302 on the suction-side bearing 303).

The suction-side bearing 303 is annular in shape and encloses a central recess 416, which is covered by the grille region 404 of the protective element 302. The recess 416 is surrounded by an inner region 411 of the bearing 303, wherein the edge region 401 of the base surface of the protective element 302 abuts the inner region 411 of the bearing 303. The bearing 303 furthermore has an outer region 414, wherein the groove 412 for accommodating the side wall 402 of the protective element 302 is formed between the inner region 411 and the outer region 414. The outer region 414 of the bearing 303, in particular a rib 417 on the outer region 414 of the bearing 303, abuts the inner side of the front wall 311 of the blower capsule 250.

The inner region 411 and the outer region 414 form a base surface of the bearing 303 that runs substantially perpendicular to the longitudinal axis 305. The bearing 303 furthermore has a side wall 415, which extends from the base surface of the bearing 303 along the longitudinal axis 305 and which is embodied to abut the inner surface of the side wall of the blower capsule 250. The side wall 415 is preferably corrugated in the circumferential direction, so that the side wall 415 has a plurality of corrugation crests and a corresponding plurality of corrugation troughs. This can increase the stability of the bearing 303. Furthermore, it can be effected that the bearing 303 contacts the inner surface of the side wall of the blower capsule 250 at a defined number of locations (i.e. (only) at the plurality of corrugation crests), so that particularly reliable support for the blower 200 can be effected.

As can be seen in FIG. 4B and FIG. 4C, the protective element 302 and the suction-side bearing 303 are preferably embodied in such a way that the outer region 414 of the suction-side bearing 303 (with an annular rib 417) contacts the inner side of the front wall 311 of the blower capsule 250 and that a gap or distance 420 is formed between the protective element 302, in particular the edge region 401 of the protective element 302, and the inner side of the front wall 311 of the blower capsule 250, so that the protective element 302 does not contact the inner side of the front wall 311 of the blower capsule 250. This makes it possible to reliably and efficiently prevent vibrations of the protective element 302 being transmitted to the blower capsule 250 and further to the suction unit 110. Thus, a particularly low-noise blower unit 300 can be provided.

Thus, a blower unit 300 is described that has an additional metal grille (as a protective element) 302 between the blower rubber buffer (i.e. the suction-side bearing) 303 and the capsule 250. The metal grille 302 serves as a protective guard. The metal grille 302 is arranged between the capsule 250 (made of plastic) and the resilient blower receptacle (i.e. the suction-side bearing) 303 into which the metal grille 302 is latched.

The protective element 302 preferably has no contact with the capsule 250 so that vibrations excited by the blower 200 and/or the air flow 240 are not transmitted to the suction unit 110. This contributes to reducing the overall device noise.

Fixing the protective element 302 in the resilient element (i.e. in the suction-side bearing) 303 causes the forces during the impact pressure test to be absorbed by the resilient element 303, so that particularly reliable contact protection can be provided.

The protective element 302 is preferably honeycomb-shaped (with hexagonal-shaped openings 405) and curved like a dome in order to effect a particularly high ratio of opening cross section to achievable rigidity. This can increase the efficiency of the blower unit 300.

Air turbulence on the protective element 302 can cause vibrations. The negative pressure during operation of the blower 200 causes the protective element 302 to be “pulled” into the blower buffer (i.e. into the suction-side bearing) 303 and thereby mechanically decoupled from the (relatively hard) blower capsule 250. This enables vibrations and noise to be reduced.

The provision of a snap-in connection between the suction-side rubber buffer (i.e. the suction-side bearing) 303 and the metal grille (i.e. the protective element) 302 enables tool-free assembly and/or disassembly, thus enabling good repairability and recyclability.

Thus, a blower unit 300 is described that has a two-part capsule 250 that supports a motor blower unit 200 that is vibration-insulated on both sides. The blower unit 300 furthermore has a protective element 302, which is arranged in the suction-side bearing 303. The protective element 302 is in particular loosely accommodated in the suction-side bearing 303. Furthermore, during operation of the motor blower unit 200, the protective element 302 has a distance 420 from the inner side of the front-side capsule part 301. This enables the transmission of vibrations from the protective element 302 to the capsule 250 to be avoided, thereby achieving noise reduction. Furthermore, this enables simple and cost-effective assembly and disassembly. In addition, this can enable the protective element 302 to be made of different materials.

In particular, a blower unit 300 for a suction device 100 is described which contains a motor-blower unit (i.e. a blower) 200. The blower unit 300 furthermore comprises a (possibly two-part) capsule 250 which accommodates the motor-blower unit 200 and supports it by means of a front-side and rear-side resilient bearing 303, 304. The blower unit 300 furthermore comprises a protective element 302 which is embodied to prevent intervention into the motor-blower unit (i.e. in the blower) 200.

The protective element 302 is preferably accommodated in the front-side (i.e. suction-side) bearing 303. Furthermore, in the operating state (when a suction-air flow 240 is present), the protective element 302 preferably has a distance 420 from the inner side of the front-side capsule part 301. In other words, in the operating state of the blower unit 300, the protective element 302 does not contact the front-side capsule part 301.

The distance 420 between the protective element 302 and the inner side of the front-side capsule part 301 is, for example, between 0.5 and 0.1 mm, preferably 0.4 mm, particularly preferably 0.3 mm. The (sheet metal) thickness of the protective element 302 can, for example, be approximately 0.4 mm.

The distance 420 between the protective element 302 and the inner side of the front-side capsule part 301 can be affected and/or defined by a circumferential rib 417 on the front-side bearing 303 extending in the direction of the front-side capsule part 301.

The protective element 302 can be dome-shaped and/or convex thereby enabling better stability under impact to be effected. In general, the protective element 302 can be flat, or curved outwardly or inwardly. Preferably, the protective element 302 is curved outwardly.

The protective element 302 can be held in an annular groove 412 in the front-side bearing 303 via one or more (offset) lugs 403. This enables a form-fitting and force-fitting connection (force-fitting due to the resilience of the material (in particular the rubber) of the bearing 303) to be provided between the protective element 302 and the bearing 303.

With regard to the angular position, the protective element 302 can preferably be positioned at any angle in the suction-side bearing 303, so that assembly can be further simplified.

The circular inner diameter of the hexagonal openings 405 of the grille region 404 of the protective element 302 is preferably less than 8.6 mm, preferably less than 5.6 mm and particularly preferably between 3 and 4 mm. This enables the requirements of DIN EN 61032 to be met in a reliable and efficient manner.

The present invention is not restricted to the exemplary embodiments shown. In particular, it should be noted that the description and the figures are only intended to illustrate the principle of the blower unit 300 and/or the suction device 100 or suction unit 110.

The following is a summary list of reference numerals and the corresponding structure used in the above description of the invention:
100 Suction device (vacuum cleaner)
110 Suction unit
111 Electrical energy store
112 Handle
113 Separator unit
114 Suction mouth
120 Accessory (suction tube)
121 Coupling
130 Nozzle
200 Blower
240 Suction-air flow
250 Blower capsule
251 Suction opening (blower capsule)
300 Blower unit
301, 305 Capsule part
302 Protective element (grille)
303 Frontside or suction-side bearing
304 Rear-side or exhaust-air-side bearing
306 Recess (capsule part)
311 Anterior or front wall (blower capsule)
350 Longitudinal axis
401 Edge region
402 Side wall (protective element)
403 Fixing lug (protective element)
404 Grille region
405 (Hexagon-shaped) grille opening
411 Inner region (suction-side bearing)
412 Fixing groove
414 Outer region (suction-side bearing)
415 Side wall (suction-side bearing)
416 Recess (suction-side bearing)
417 Rib (suction-side bearing)
420 Distance (blower capsule vs. protective element)

1. A blower unit for a suction device, the blower unit comprising:
a blower capsule;
a blower disposed in said blower capsule and embodied to affect a suction-air flow along a flow direction running from a suction side to an exhaust-air side of the blower unit during operation;
a suction-side bearing and an exhaust-air-side bearing for supporting said blower on an inner side of said blower capsule; and
a protective element disposed on said suction-side bearing, said protective element embodied to be flowed through by the suction-air flow and to provide contact protection for said blower, wherein said protective element is disposed on said suction-side bearing such that said protective element is at a distance from said inner side of said blower capsule when said blower is in operation.

2. The blower unit according to claim 1, wherein said protective element is disposed on said suction-side bearing such that said protective element is pulled away from said inner side of said blower capsule by an action of the suction-air flow when said blower is in operation, so that said protective element is at the distance from said inner side of said blower capsule.

3. The blower unit according to claim 1, wherein:
the distance is between 0.1 mm and 0.5 mm; and/or
said protective element has a thickness perpendicular to the flow direction of the suction-air flow; and
the distance is between 0.5 and 1.2 times a thickness of said protective element.

4. The blower unit according to claim 1, wherein:
said blower capsule has a front wall on the suction side of the blower unit;
said front wall has a recess formed therein; and
said protective element covers said recess of said front wall of said blower capsule from said inner side of said housing capsule.

5. The blower unit according to claim 4, wherein:
said suction-side bearing has an outer region facing an inner side of said front wall of said blower capsule;
said suction-side bearing has a rib which protrudes from a surface of said outer region, is disposed on said outer region of said suction-side bearing and contacts said inner side of said front wall of said blower capsule; and
said rib defines the distance between said protective element and said inner side of said blower capsule.

6. The blower unit according to claim 5, wherein:
said suction-side bearing has an inner region facing said inner side of said front wall of said blower capsule;
said protective element has an edge region which abuts said inner region of said suction-side bearing; and
said edge region of said protective element is disposed between said inner side of said front wall of said blower capsule and said inner region of said suction-side bearing.

7. The blower unit according to claim 6, wherein the blower unit is embodied such that said edge region of said protective element is pulled toward said inner region of said suction-side bearing, when said blower is in operation, so that a distance between said edge region of said protective element and said inner side of said front wall of said blower capsule is produced.

8. The blower unit according to claim 6, wherein:
said protective element has a side wall extending away from said edge region of said protective element toward said exhaust-air side of the blower unit; and
said suction-side bearing has a groove formed therein between said inner region and said outer region in order to accommodate said side wall of said protective element.

9. The blower unit according to claim 8, wherein said protective element has at least one fixing lug on said side wall and/or as part of said side wall, said at least one fixing lug is embodied to effect a force-fitting connection between said protective element and said suction-side bearing within said groove of said suction-side bearing.

10. The blower unit according to claim 5, wherein:
said suction-side bearing has a side wall extending from said outer region of said suction-side bearing to said exhaust-air side of the blower unit;
said side wall runs around a longitudinal axis of the blower unit;
the longitudinal axis of the blower unit extends from said suction side to said exhaust-air side of the blower unit;
said side wall is corrugated in a circumferential direction around the longitudinal axis with a plurality of corrugation crests; and
said side wall of said suction-side bearing contacts said inner side of said blower capsule with said plurality of corrugation crests.

11. The blower unit according to claim 1, wherein:
said protective element has a grille region with a plurality of grille openings formed therein and through said grille openings the suction-air flow flows when said blower is in operation;
individual ones of said grille openings are in each case hexagonal in shape; and
an inner diameter of said individual grille openings is each case 8.6 mm or less.

12. The blower unit according to claim 11, wherein said grille region of said protective element is curved.

13. The blower unit according to claim 1, wherein said protective element is made of metal.

14. The blower unit according to claim 1, wherein:
said suction-side bearing is resilient; and/or
said suction-side bearing is made of a resilient material.

15. The blower unit according to claim 1, wherein:
said blower capsule has a suction-side capsule part and an exhaust-air-side capsule part, which are detachably connected to one another;
said suction-side bearing is embodied to support said blower on an inner side of said suction-side capsule part of said blower capsule; and
said exhaust-air-side bearing is embodied to support said blower on an inner side of said exhaust-air-side capsule part of said blower capsule.

16. The blower unit according to claim 5, wherein said rib is an annular rib.

17. The blower unit according to claim 7, wherein said protective element is pulled toward said inner region of said suction-side bearing by an action of the suction-air flow.

18. The blower unit according to claim 8, wherein said groove is an annular groove.

19. The blower unit according to claim 10, wherein said plurality of corrugation crests are evenly distributed corrugation crests around the circumferential direction.

20. The blower unit according to claim 14, wherein said suction-side bearing is made from rubber.
